(19) United States
(12) Patent Application Publication
(10) Pub. No.: US 2004/0267411 A1
(43) Pub. Date: Dec. 30, 2004

(54) Automated hauling yard

(76) Inventors: Christian Mayer, Reutlingen (DE); Andreas Schwarzhaupt, Oberrot (DE); Gernot Spiegelberg, Heimsheim (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/847,658

(22) Filed: May 18, 2004

(30) Foreign Application Priority Data
May 19, 2003 (DE) 103 22 765.2

(51) Int. Cl. G06F 19/00

(52) U.S. Cl. 701/1; 701/29

(57) ABSTRACT

An automated hauling yard (1) for transporting vehicle autonomously having an incoming vehicle station (3) which is for handing over, to the hauling yard (1), vehicle (10) which has been transferred manually to the incoming vehicle station (3) by a vehicle driver, and in which station vehicle data is transferred to a supervisory computer (39) of the hauling yard (1). An unloading station (4) function based on vehicle data and serves the maintenance station (5) maintains the vehicle also as a function vehicle data. A loading station (6) loads the vehicle as a function of the vehicle data, the means (10) of transportation which has been transferred there, having a pickup station (7) which hands or of handing over the vehicle to the vehicle driver.

### BACKGROUND AND SUMMARY OF THE INVENTION

This application claims the priority of German Patent Document No. 103 22 765.2, filed 18 May 2003, the disclosure of which is expressly incorporated by reference herein, respectively.

The present invention relates to an automated hauling yard, operating mode yard or a logistics center for trucks which can travel autonomously.

In a hauling yard, a number of trucks are loaded and unloaded on a daily basis. Furthermore, such a hauling yard may be equipped with a workshop and with a refueling station in order to be able to refuel and maintain the trucks, and if appropriate repairs may also be carried out. Such a hauling yard usually only has a limited area of land so that the trucks on the hauling yard have to be constantly maneuvered, which is both time-consuming and also entails risks. In particular, a person giving directions is necessary for the maneuvering, particularly for reversing the truck, in order to reduce the risk of collisions between the truck and an obstacle. Furthermore, the personnel requirements for moving the trucks within the hauling yard are comparatively large, the persons giving directions also being a factor here. There is thus a need to simplify the operation of a hauling yard to a degree in order to reduced deployment of personnel.

European Patent EP 0 971 276 A1 discloses a lawnmower which can travel autonomously and which is equipped with a position-determining device, for example a GPS receiver. A control device of the lawnmower includes a learning mode in which the lawnmower is operated manually. The lawnmower memorizes the path traveled. In a self-propelling mode, the lawnmower can retrace the previously learned path automatically, that is to say autonomously.

European Patent EP 0 423 332 B1 discloses a vehicle which can travel autonomously and which can retrace stored reference courses. For this purpose, the vehicle is equipped with a position-sensing device which can determine the instantaneous position of the vehicle by means of time differences which arise due to different transit times of signals which are emitted synchronously by means of transmitter stations which are distributed positionally.

European Patent EP 0 297 811 A2 discloses an unmanned vehicle which can follow a stored path in a factory autonomously. The vehicle orients itself by means of physical features which characterize the surroundings to the side of the path to be traveled along.

German Patent DE 100 32 179 A1 discloses a control system for a vehicle which is equipped with an electronically actuable drive train. The control system include an operator control device which is fixed to the vehicle and into which a vehicle driver can input a driver request (for example accelerating, steering) into the steering system and which transforms the driver request into a movement vector. This movement vector is transferred to a control device for generating control signals transmitted to the drive train. The drive train can then process the control signals in order to implement the driver request. Such a control system can also be referred to as a drive-by-wire system or as an X-by-wire system in which the individual components of the drive train, for example steering system, brake system and drive assembly, are controlled electronically without a continuous mechanical or hydraulic connection to the respective component of the drive train, between corresponding operator control elements, for example steering wheel, joystick, accelerator pedal or brake pedal.

The present invention is concerned with specifying, for a hauling yard, an operating mode yard or a logistics center, an improved embodiment which in particular requires only a reduced deployment of personnel. Furthermore, the operational reliability of the hauling yard is improved.

The invention is based on the concept of configuring the hauling yard for dispatching trucks or else buses which can travel autonomously, including different stations to which the trucks can be moved autonomously within the hauling yard. In the present context, “autonomous” travel operating mode is understood to mean a travel operating mode in which there is no need for a vehicle driver to be present in the truck. The operator control elements which are present in the cockpit for operating the truck manually, for example steering wheel, accelerator pedal, brake pedal or gear shift, are not activated during autonomous travel operating mode. In the hauling yard according to the invention, the vehicle driver delivers his truck to the hauling yard at an incoming vehicle station. From this point onward, the truck is then only moved autonomously from station to station. It is clear here that within the individual stations the truck can perfectly well also still be operated manually. After the truck has passed through an unloading station, a maintenance station and a loading station, it is made available for the next journey in an outgoing vehicle station where it can be picked up again by the same vehicle driver or by another vehicle driver. Because the trucks can travel autonomously within the hauling yard, there is no need for vehicle drivers in order to transfer the trucks manually from one station to the next. To this extent it is possible to achieve a saving in personnel. Furthermore, the autonomous travel operating mode can readily be configured in such a way that the transfer of the truck from one station to the next takes place essentially automatically so that personnel are only necessary to supervise orderly processing.

According to advantageous embodiments, the hauling yard can also be equipped with an automatic refueling station and/or with an automatic wash station in order to refuel and wash the respective truck when necessary.

According to one particularly advantageous embodiment, a truck which is suitable for the hauling yard according to the invention, that is to say a truck which can travel autonomously, is equipped with an electronically actuable drive train and with a control system which operates according to the drive-by-wire principle or else according to the X-by-wire principle, and is described, for example, in German Patent DE 100 32 179 A1 which is incorporated herein by reference. The control system which is known per se includes a manual operator control device which is fixed to the vehicle and is supplemented according to the invention by at least one autonomous operator control device by means of which a driver request can be input for the autonomous vehicle operating mode and which generates, from the driver request, a standardized movement vector which can be processed by the control device of the drive train. This is accomplished by a drive train interface by means of which both the manual operator control device which is present in any case and the at least one additional autonomous operator control device are coupled to the control device. The present invention thus makes use of the fact that trucks which have an electronically actuable drive train are particularly suitable for use in an autonomous operating mode since all that is necessary is to use a suitable autonomous operator control device to generate essentially the same standardized movement vector which is also generated by the vehicle driver in the manual operating mode by means of the operator control device mounted in the vehicle. This movement vector which is generated by the autonomous operator control device then has to be suitably fed to the control device of the control system, which control device then passes it on—in the same way as a movement vector generated by the manual operator control device—to the drive train for processing. It is possible to dispense with additional actuator elements for activating the operator control elements which are mounted on the vehicle. The expenditure on implementing such autonomous operator control devices is accordingly comparatively small since only one suitable interface, specifically the drive train interface, has to be provided.

The features which are mentioned above and the features which are to be explained below can be used not only in the respectively specified combination but also in other combinations or in isolation, without departing from the scope of the present invention.

Preferred exemplary embodiments of the invention are illustrated in the drawings and will be explained in more detail in the following description, identical reference symbols referring to identical or functionally identical or similar components.

### BRIEF DESCRIPTION OF THE DRAWINGS

FIG. 1 is a schematic plan view of a hauling yard according to the invention, in a highly simplified basic illustration,

FIG. 2 shows a schematic, circuit-diagram-like basic illustration of a control system of a truck which is suitable for the hauling yard.

### DETAILED DESCRIPTION OF THE PREFERRED EMBODIMENT

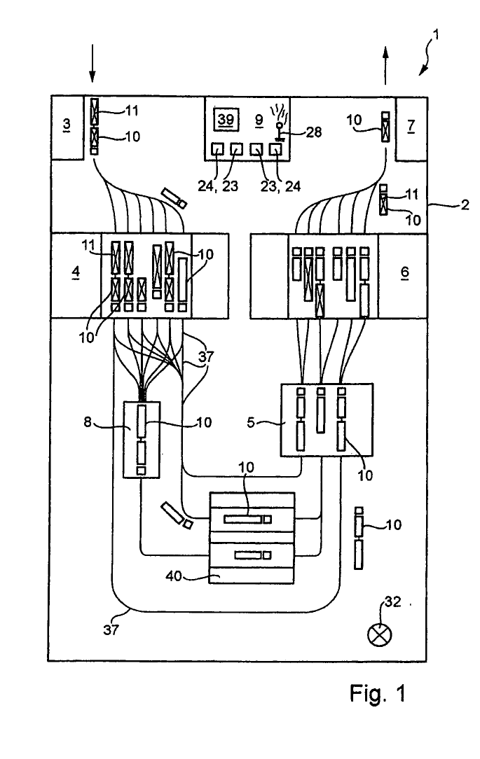

According to FIG. 1, a hauling yard 1 according to the invention has an area of land 2 which is expediently closed off from the outside. On this area of land 2, the hauling yard 1 including at least one incoming vehicle station 3, at least one unloading station 4, at least one maintenance station 5, at least one loading station 6 and at least one pickup station 7. The specific embodiment shown here also includes a refueling station 40 and a wash station 8. Furthermore, a remote control center 9 is provided. The hauling yard 1 is automated and is provided for use with trucks 10 which can travel autonomously. The trucks 10 can be single-element trucks 10 without a trailer or tracks 10 composed of a traction engine and trailer, in particular semitrailer vehicles 10. In the illustration according to FIG. 1, the trucks 10 which are loaded with a payload 11 are designated by an X, while the trucks 10 without loads are presented without such an X.

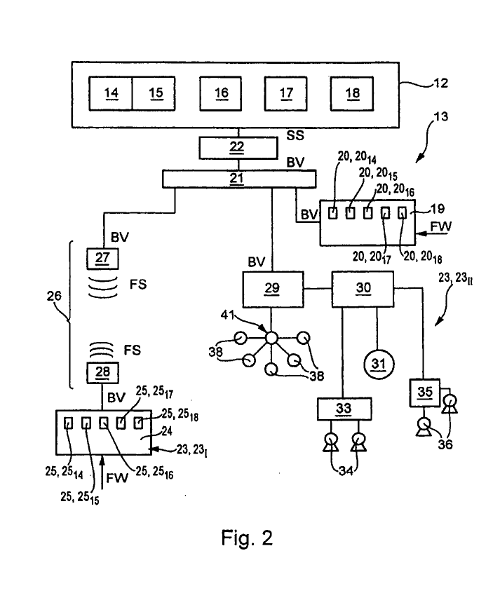

Trucks 10 which can be processed in the hauling yard 1 according to the invention are configured as trucks which can travel autonomously. According to FIG. 2, such trucks 10 are preferably equipped with a control system 13 which comprises an electronically actuable drive train 12. This drive train 12 has, for example, a drive assembly 14, a transmission 15 which is coupled to it, a steering system 16, a brake system 17 and here, by way of example, also a ride control device 18. The control system 13 includes a manual operator control device 19 which is permanently installed in the respective truck 10 and which has operator control elements 20. The operator control elements 20 can be activated manually by a vehicle driver and are assigned to the individual components 14 to 18 of the drive train 12. In particular, the operator control elements 20 include an accelerator pedal 20₁₄, a gear shift 20₁₅, a steering wheel or a joystick 20₁₆, a brake pedal 20₁₇ and a control element 20₁₈ for activating the ride control device 18. The vehicle driver can use the manual operator control device 19 to input into the control system 13 a driver request FW which is symbolized by an arrow. The manual operator control device 19 generates a movement vector BV at its output end from the input-end driver request FW and is connected at the output end to a drive train interface 21. In addition, a control device 22 of the control system 13 is connected to this drive train interface 21. This control device 22 can generate control signals SS which originate from the incoming movement vector BV, and feed these signals SS to the drive train 12 or its components 14 to 18. The drive train 12 and its components 14 to 18 can then process the control signals SS, as a result of which the original driver request FW is implemented.

According to the invention, this control system 13 is expanded by at least one autonomous operator control device 23. In the embodiment shown here, by way of example, two such autonomous operator control devices 23 are provided: specifically a first autonomous operator control device 23_{I} and a second autonomous operator control device 23_{II}. Likewise, further autonomous operator control devices 23 may be provided.

Each autonomous operator control device 23 is connected to the drive train interface 21 and is also configured in such a way that it can be used to input driver requests FW for the autonomous operating mode of the truck 10, the autonomous operator control device 23 also generates movement vectors BV from the driver requests FW. The movement vectors BV are standardized for this purpose. For example, the movement vector BV is a standardized bus protocol, in particular a CAN bus protocol. Since the movement vectors BV are standardized, in the autonomous operating state of the truck 10, the control device 22 can also convert the movement vectors BV—generated by the respective autonomous operator control device 23—into control signals which are then processed accordingly by the drive train 12.

The first autonomous operator control device 23_{I} is essentially a remote control device 24 which is also equipped with suitable operator control elements 25 which are correspondingly assigned to the individual components 14 to 18 of the drive train 12. The remote control device 24 is arranged remotely from the truck 10 and as a result, permits the autonomous operating mode of the truck 10 since vehicle driver is not required in the truck 10. The remote control device 24 generates again the standardized movement vector BV from the ingoing driver request FW and is connected to the drive train interface 21 via a transceiver arrangement 26. The transceiver arrangement 26 includes a transceiver unit 27 which is fixed to the vehicle and is connected to the drive train interface 21, as well as a transceiver unit 28 which is remote from the vehicle and is connected to the remote control device 24. The transceiver arrangement 26 expediently operates in a wire free fashion by means of electromagnetic waves. Correspondingly, in order to transmit the movement vector BV between the units 27, 28 of the transceiver arrangement 26, the latter is firstly converted into a remote control signal FS and converted back into the movement vector BV again after the remote transmission.

The remote control device 24 is arranged together with the transceiver unit 28, remote from the vehicle, in the remote control center 9 at the hauling yard 1. As is apparent from FIG. 1, the remote control center 9 can have a plurality of such remote control devices 24 or a plurality of such autonomous operator control devices 23. The remote control devices 24 of the remote control center 9 are expediently connected here to a common transceiver unit 28 which is remote from the vehicle.

According to FIG. 2, the second autonomous operator control device 23_{II} can have at least one path-calculating device 29 and at least one orientation and position-determining device 30 which is connected thereto. The orientation and position-determining device 30 is configured in such a way that it can determine, for example, the orientation and position of the respective truck 10. “Position” is understood here to be the geographical location of the truck 10, while “orientation” specifies the orientation of the longitudinal axis of the truck 10 with respect to a coordinate system which is fixed to the earth, expediently the compass directions. Alternatively, an embodiment is also possible in which the device 30 for determining the orientation and position is configured in such a way that it determines only the relative orientation and position of the truck 10 with respect to the next traveled to station of the hauling yard 1. The device 30 for determining the orientation and position can transmit the determined orientation and position of the path-calculating device 29, which then generates movement vectors BV which are updated continuously as a function of the current orientation and position of the truck 10. That is, the sequence of movement vectors BV. The movement vectors BV which are generated by the path-calculating device 29 guide the truck 10 to the next station of the hauling yard 1 to be traveled to when they are processed by the drive train 12.

In the illustrated embodiment, the path-calculating device 29 is installed permanently in the truck 10. In another embodiment the path-calculating device 29 can be arranged outside the truck, in particular in the remote control center 9 of the hauling yard 1. The path-calculating device 29 which is removed from the truck 10 can then communicate with the drive train interface 21 via a transceiver arrangement.

With the architecture of the illustrated control system 13, the device 30 for determining the orientation and position is connected directly to the path-calculating device 29. It is also possible for the path-calculating device 29 and device 30 to determine the orientation and position for both connection to the drive train interface 21 and communication with one another. The drive train interface 21 then forms a star point.

The device 30 for determining the orientation and position is also permanently installed in the truck 10. Alternatively, there may also be provision for the device 30 for determining the orientation and position also to be arranged—depending on the functional principle—outside the truck 10, in which case a transceiver arrangement may also be provided for communication with the drive train interface 21. For example, the device 30 for determining the orientation and position can then be composed of a sensor system which operates with a plurality of sensors which are distributed on the area of land 2 of the hauling yard 1, which sensors permit the orientation and position of the trucks 10 which are moved on the area of land 2 to be determined. In particular, the sensor system can operate according to the radar principle.

A device 30—fixed to the vehicle—for determining the orientation and position can operate, for example, with a satellite navigation receiver 31 which is mounted on the truck 10. The satellite navigation receiver 31 is expediently a GPS receiver. A higher degree of accuracy for the determination of position can be obtained using a DGPS (differential GPS) receiver which interacts with a terrestrial DGPS reference station 32 which, according to FIG. 1, is expediently arranged at the hauling yard 1. In order to determine the orientation of the truck 10 it can be equipped with at least one compass which can be read out. The method of operation of such an orientation- and position-determining device 30 is explained in more detail in German Reference DE 100 31 244 A1, the contents of which are incorporated herein by reference.

In one alternative embodiment, the orientation- and position-determining device can have an image-recognition device 33 which operates with at least one camera 34. Camera images are generated using the cameras 34 and then compared with stored images of the hauling yard 1. From this comparison it is then possible to determine the current orientation and position of the truck 10 within the hauling yard 1. In the process, the image-recognition device 33 and/or the cameras 34 can be mounted, as here, on the truck 10. It is also possible to arrange such an image-recognition device 33 with cameras 34 in a fixed fashion at the hauling yard 1, for example in the remote control center 9.

In another alternative, the orientation- and position-determining device 30 can have a lane-detection device 35 which also operates with at least one camera 36. The lane-detection device 35 and its cameras 36 are permanently installed on trucks 10 and interact with driving path marks which correspond essentially to the lane lines 37 shown in FIG. 1. The lane-detection device 35 can detect the driving path marks and—if a plurality of different driving path marks are provided—possibly distinguish them from one another. On the basis of these driving path marks, the lane-detection device 35 can determine the current orientation- and position-determining device 30 of the truck 10 in such a way that the path-calculation device 29 can calculate movement vectors BV which, during their processing in the drive train 12, cause the respective truck 10 to follow the respective driving path mark and thus pass from one station to the next.

When the movement vectors BV are determined, the path-calculation device 29 can expediently take into account ambient conditions in the surroundings of the respective truck 10. In this way, collisions between the truck 10 and an obstacle can be avoided. For example, these ambient conditions of the path-calculation device 29 may be made available in a stored form. The ambient conditions of one or more hauling yards 1 are then stored in a corresponding memory so that, given knowledge of the current orientation and position of the truck 10, the path-calculation device 29 can reliably drive around fixed and known obstacles of the respective hauling yard 1. It is expedient here to equip the path-calculation device 29 additionally with a sensor system 41 which comprises a plurality of sensors 38. Using the sensor system 41 it is possible to determine critical distances between the truck 10 and obstacles and take them into account during the calculation of the movement vectors BV. It is basically possible here to mount such distance sensors 38 directly on the truck 10. Alternatively, the distance sensors 38 can also be mounted at critical locations in the hauling yard 1, which is advantageous in particular if the path-calculation device 29 is mounted in any case at the hauling yard 1. It is also possible for the sensors 38 which are mounted at the hauling yard 1 to communicate via a corresponding transceiver arrangement, for example again via the drive train interface 21, with the path-calculation device 29 which is mounted fixed to the vehicle.

Furthermore, it is expedient if the path-calculation device 29 takes into account the vehicle dynamics during the determination of the movement vector BV in order to prevent the vehicle 10 from tipping over. Likewise, the speed of the vehicle should be limited to a relatively small value in order to keep the risk of damage as low as possible.

The automated hauling yard 1 according to the invention operates as follows:

The vehicle driver manually drives the truck 10, laden with an “old” payload, to the hauling yard 1 as destination for the old payload, by using the manual operator control device 19 fixed to the vehicle (FIG. 2). The vehicle driver transfers the truck 10 manually to the incoming vehicle station 3. There, the truck 10 is handed over by the vehicle driver to the hauling yard 1. In the process, the vehicle data is transferred manually or by means of a suitable data carrier, or transferred telemetrically to a supervisory computer 39 of the hauling yard 1. This vehicle data contains, in particular, a vehicle identification code and a payload identification code. After the vehicle driver has handed over his truck 10 to the hauling yard 1, only an autonomous driving mode of the truck 10 generally then takes place between the individual stations of the hauling yard. At first, the truck 10 is transferred autonomously from the incoming vehicle station 3 to the unloading station 4. There, the truck 10 is unloaded, in a preferably automated fashion, using the payload identification code. The payload of the truck 10 is generally one or more containers which can be unloaded particularly easily.

After the truck 10 has been unloaded, it is transferred autonomously to the maintenance station 5. There may be provision here for the truck 10 also to be taken, according to requirements, to the wash station 8 and/or the refueling station 40 before the maintenance station 5. The necessity to refuel and wash a vehicle can already also be included in the vehicle data when the truck 10 is handed in. Accordingly, the washing and the refueling of the vehicle 10 can also be carried out as a function of the vehicle data. The truck 10 is therefore unloaded as a function of the vehicle data which includes data about the old payload.

The washing system 8 expediently operates completely automatically. The refueling station 40 can also be automated to a greater or lesser extent.

In the maintenance station 5, routine inspection of the track 10 is carried out, in particular in order to check worn parts. In the process, different electronic diagnostic systems may be applied in order to determine the respective maintenance requirements of the truck 10. In particular there may be provision for automatic and telemetric exchange of data to be carried out between the maintenance station 5 and the respective truck 10 in order to determine the maintenance requirements. Correspondingly, the maintenance is also carried out as a function of the vehicle data. As far as possible, the maintenance is also automated at the maintenance station 5.

After the maintenance, the truck 10 is taken to the loading station 6 which provides the truck 10 with a “new” payload as a function of the respective truck 10. The loading station 6 also operates in a largely automated fashion. After the loading operation, the truck 10 is ready for a new run to a new destination and is firstly transferred autonomously from the loading station 6 to the outgoing vehicle station 7. There, the truck 10 which has been prepared is taken over again by the original vehicle driver or by another vehicle driver and driven away manually.

As a result of the use of autonomous operator control devices 23 which make it possible to control the trucks 10 remotely, in particular from the remote control center 9, it is possible to supervise and process correctly a relatively large number of trucks 10 simultaneously with a minimum deployment of personnel. The risk of damage to the trucks 10 or to the buildings of the hauling yard 1 and the risk of injury by vehicle drivers and people giving directions and other auxiliary personnel is thus considerably reduced.

As explained, the individual stations of the hauling yard 1 always process the respective trucks 10 as a function of the associated vehicle data, as a result of which vehicle-specific processing is carried out. In particular, the loading and unloading stations 4, 6 detect the size of the payload and the range of the respective truck by means of the vehicle data. For this purpose, the individual stations are connected to the supervisory computer 39.

The supervisory computer 39 forms a coordinating central control point of the hauling yard 1 according to the invention. It actuates the respective truck 10, for example by means of radio, and can issue all the necessary instructions to the automated wash station 8 and to the automated refueling station 40, and administers the handling of containers in the loading station 4 and the unloading station 6.

The wash station 8, which operates in an automated fashion, may be a standard washing system which vehicles can also travel through in a manual conventional fashion. The signals, for example start, stop and travel speed, which are issued as commands to the respective vehicle driver by means of a traffic light when the vehicles travel through manually, are passed on to the supervisory computer 39 by means of a field bus system in the autonomous operating mode. In the autonomous operating mode, the supervisory computer 39 then guides the truck 10 through the wash station 8 instead of the vehicle driver.

In the refueling station 40, which is equipped in an automated fashion, the respective truck 10 is refueled, for example, by a robot. Such a robot can be activated by the supervisory computer 39 by means of simple commands, for example “truck present” and “fill up”. The refueling station 40 signals, for example, the quantity of fuel delivered, back to the control computer 39.

The truck 10, which travels autonomously, receives the respective instructions (movement vectors BV) from the supervisory computer 39, for example via the transceiver unit 27 which is fixed to the vehicle, and can also provide the supervisory computer 39 with information about the current state of the vehicle (for example speed and position). The autonomous operator control device 23 calculates the respectively necessary movement vector BV from the incoming data which represents the respective driver request FW, and from the vehicle position and vehicle orientation which are supplied in particular by the GPS receiver 31. The movement vector BV is then transferred to the drive train 12 via the drive train interface 21, and to the control device 22.

In one specific embodiment, a reversing device, which, during the reversing of the truck 10, modifies the movement vector BV in such a way that the truck 10 travels backwards along the desired path without the train 10 jackknifing, can preferably be connected between the prescription level formed by the respective operator control device 19 or 23 and the execution level formed by the control device 22 in the case of a train 10.

The control device 22 which is provided for activating the drive train 12 causes the driver request FW to be implemented by processing the movement vectors BV. Moreover, this control device 22 can also actuate a container control device (not shown here) with which, for example, supports of the container can be extended and retracted automatically. Such a container control device is described for example, in German Patent DE 195 26 702 C2, whose contents are incorporated herein by reference.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed:

1. An automated vehicle handling system, comprising:
an incoming vehicle station for handing over to the system a vehicle which has been transferred to the incoming vehicle station manually by a vehicle driver wherein incoming vehicle station vehicle data is transferred to a supervisory computer of the system;
first means for transporting the vehicle to a first subsequent station from said incoming station, said first subsequent station including an unloading station which unloads the vehicle as a function of said vehicle data;
second means for transporting the vehicle from said first subsequent station to a second subsequent station wherein said second subsequent station includes a maintenance station which maintains the vehicle as a function of said vehicle data;
third means for transporting said vehicle from said second subsequent station to a third subsequent station wherein said third subsequent station includes a loading station for loading the vehicle as a function of the vehicle data;
fourth means for transporting said vehicle from said third subsequent station to a fourth subsequent station wherein said fourth subsequent station includes a pick up station for handing over the vehicle to the vehicle driver as a function of the vehicle data wherein subsequently the vehicle is driven away manually by the vehicle driver.

2. The vehicle handling system according to claim 1, further including at least one of a refueling state and a wash station and additional means for transporting said vehicle to and from each of said at least one refueling station and wash station.

3. The automated vehicle handling system according to claim 2, wherein said refueling station automatically refuels said vehicle and wherein said wash station automatically washes said vehicle and annually floating station automatically loads said vehicle and wherein said unloading station automatically unloads said vehicle.

4. The vehicle handling system according to claim 1, wherein said maintenance station includes means to perform an automatic and telemetric exchange of data in order to determine maintenance requirement of said vehicle.

5. The vehicle handling system according to claim 1, wherein said vehicle includes an electronically actuable drive train including at least one driver assembly, one steering system, one break system and a control system wherein said control system includes a manual operator control device permanently installed on said vehicle by which a driver request can be input by a vehicle driver for manual operation of the vehicle and which generates a standard movement vector from the driver request, and wherein said control system includes at least one autonomously operator control device by which the driver request can be input for autonomously operation of the vehicle and which generates a standardized movement vector from the driver request, said control system further including a control device generating control signals from input movement vectors wherein said control device transmits the control signals to the drive train which processes the control signals in order to implement a driver request, said control system further including a drive train interface whereby the manual operator control device and said at least one autonomously operator control device are coupled to the control device in order to transmit said movement vectors.

6. The vehicle handling system according to claim 5, wherein the autonomously operator control device is a remote control device remote from said vehicle and arranged in a remote control center of the vehicle handling system and wherein said remote control device is connected by a transceiver arrangement to a drive train interface of the vehicle.

7. The vehicle handling system according to claim 6, wherein said remote control center simultaneously performs remote control for a plurality of vehicles.

8. The vehicle handling system according to claim 5, wherein the autonomously operator control device includes at least one path-calculating device and at least one orientation and position-determining device for determining the absolute orientation and position of the vehicle or the orientation of the position of the vehicle with respect to the system or to the nearest station and wherein the path-calculating device generates, as a function of the orientation and position of the vehicle, a subsequent of movement vectors which transfer the vehicle to a next station to be driven to.

9. The vehicle handling system according to claim 8, wherein the path-calculating device is one of permanently installed in the vehicle and arranged outside the vehicle in a remote control sender of the system and is connected to a drive train interface of the vehicle by a transceiver arrangement.

10. The vehicle handling system according to claim 8, wherein the orientation and position-determining device is one of permanently installed in the vehicle and arranged outside the vehicle and is connected to a drive train interface by a transceiver arrangement.

11. The vehicle handling system according to claim 10, wherein the orientation and position-determining device is one of a GPS receiver and a DGPS receiver with a DGPS reference station arranged in or at system.

12. The vehicle handling system as claimed in claim 12, wherein the orientation and position-determining device includes an image-detection device with at least one camera which compares camera images with stored images of the system and determines a current orientation and position of the vehicle.

13. The vehicle handling system as claimed in claim 10, wherein the orientation and position-determining device has a lane-detection device with at least one camera which detects a driving path mark which is arranged in or at the system and thus determines the current orientation and position of the vehicle.

14. The vehicle handling system according to claim 8, wherein the path-calculating device calculates the successive movement vectors as a function of ambient conditions in the surroundings of the vehicle wherein said conditions are stored in the path-calculating device or determined by a sensor system.

15. The vehicle handling system according to claim 1, wherein said system is a hauling yard.

16. The vehicle handling system according to claim 1, wherein said system is a logistics center for vehicles.
